(19) United States
(12) Patent Application Publication
(10) Pub. No.: US 2009/0301855 A1
(43) Pub. Date: Dec. 10, 2009

(54) ROTATABLE INPUTTING APPARATUS

(75) Inventor: Eung Cheon KANG, Hwaseong-si (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., Suwon (KR)

(21) Appl. No.: 12/258,515

(22) Filed: Oct. 27, 2008

(30) Foreign Application Priority Data
Jun. 9, 2008 (KR) 10-2008-0053637

(51) Int. Cl. H01H 13/72

(52) U.S. Cl. 200/5 A

(57) ABSTRACT

Disclosed herein is a rotatable inputting apparatus. When a circuit board of the rotatable inputting apparatus is coupled to a main circuit board of a terminal or remote control, the rotatable inputting apparatus of the invention allows reference points of the boards to be instinctively recognized without the necessity of forming reference projections or using screws, thus enabling its easy assembly. The rotatable inputting apparatus includes a wheel having a ring magnet, a support having a pressure pin, a center key moving in a vertical direction, a dome seat including a central dome button and peripheral dome buttons, a circuit board to which the dome seat is attached, and a connecting guide which is secured to the circuit board and has a connecting part. The connecting part passes through the circuit board and is inserted into the main circuit board.

### CROSS REFERENCE TO RELATED APPLICATION(S)

This application claims the benefit of Korean Patent Application No. 10-2008-0053637, filed on Jun. 9, 2008, entitled “rotatable inputting apparatus”, which is hereby incorporated by reference in its entirety into this application.

### BACKGROUND OF THE INVENTION

1. Field of the Invention

The present invention relates generally to a rotatable inputting apparatus which is mounted to a terminal, such as a mobile communication terminal or a PDA, or a remote control and, more particularly, to a rotatable inputting apparatus which can be coupled to a main circuit board of a terminal or remote control while reference points are instinctively recognized without the necessity of forming reference projections or using screws, when a circuit board of the rotatable inputting apparatus having a dome-shaped switch, a wheel, and other parts is coupled to the main circuit board, thus enabling its easy assembly.

2. Description of the Related Art

Generally, a portable terminal such as a mobile communication terminal or a PDA, or a remote control for controlling a TV or machine from a distance is provided with a navigation key to perform various functions of the machine, that is, the search for a menu and a phone number, the adjustment of volume, and the change of a channel.

The navigation key includes a button which recognizes the manipulation force applied by a user, a wheel which is rotated in a forward or backward direction by the user, and a sensor which detects the rotation of the wheel.

Such a conventional rotatable inputting apparatus having the button and the wheel includes a wheel, a center key, a support holder, a dome seat and a circuit board.

The wheel is the member which is rotated in a forward or backward direction by a user. A multi-pole ring magnet is provided on the lower edge of the wheel. The rotating angle, direction, and speed of the wheel constructed as described above are detected by a magnetic device of a circuit board. Further, the wheel has in a central portion thereof a center key which is movable up and down. When the center key is pushed by a user, the center key presses a central dome button of the dome seat.

The support holder rotatably supports the wheel, and is secured to the circuit board. When the wheel is pushed by a user, a pressure pin of the support holder pushes peripheral dome buttons of the dome seat.

The central dome button is provided on the central portion of the dome seat to correspond to the center key, and the peripheral dome buttons are provided around the central dome button. The peripheral dome buttons are arranged to be pushed by the pressure pin. Further, the dome seat is attached to and supported by the upper surface of the circuit board.

The dome seat is attached to the upper surface of the circuit board to be electrically connected to the circuit board. The circuit board is provided with the magnetic device which detects the rotation of the wheel.

However, the conventional rotatable inputting apparatus constructed as described above is problematic in that holes must be bored through both sides of the circuit board of the rotatable inputting apparatus, and the circuit board must be assembled with a main circuit board of an objective product using screws, so as to precisely place and mount the inputting apparatus on the main circuit board of the objective product, such as a remote control or a mobile phone, so that the number of assembly processes is increased.

Further, the conventional rotatable inputting apparatus is problematic in that, when the rotatable inputting apparatus is placed on the main circuit board of the objective product, it is difficult to set the reference position of the rotatable inputting apparatus, so that the assembly period is relatively long.

### SUMMARY OF THE INVENTION

The present invention has been made in an effort to provide a rotatable inputting apparatus, which is provided with a connecting guide, thus allowing the reference position of the rotatable inputting apparatus to be easily set, and allowing a circuit board of the rotatable inputting apparatus to be easily coupled to a main circuit board of an objective product, when the rotatable inputting apparatus is placed and mounted on the main circuit board of the objective product such as a remote control or a mobile phone, therefore reducing the number of assembly processes and the assembly period.

In a rotatable inputting apparatus mounted to a product having a main circuit board according to an embodiment of the present invention, a wheel has in a central portion thereof a center hole, is rotated by a rotating manipulating force, and has a ring magnet. A support holder rotatably supports the wheel and has on an edge thereof at least one pressure pin. A center key passes through the center hole of the wheel and moves in a vertical direction. A dome seat includes a central dome button which generates a signal by pushing force of the center key and the pressure pin, and one or more peripheral dome buttons which are provided around the central dome button at regular intervals. A circuit board includes a circuit for transmitting a signal from the central and peripheral dome buttons, and a magnetic device for detecting a rotation of the ring magnet of the wheel, and the dome seat is attached to the upper surface of the circuit board. A connecting guide comes in close contact with the upper surface of the circuit board such that at least portion of the connecting guide is exposed to a lower surface of the circuit board. The exposed portion is inserted into the main circuit board to connect the circuit board to the main circuit board.

The circuit board includes on an outer circumference thereof two connecting pieces in which first and second through holes are formed, respectively, portion of the connecting guide being connected to the first and second through holes.

Further, the first and second through holes have different diameters.

The connecting guide includes a ring part which comes into close contact with the dome seat in such a way as to surround the central dome button, an extension part which extends from each of opposite ends of the ring part and comes into close contact with the dome seat, and a connecting part which extends vertically from an end of the extension part to pass through the circuit board and thereby be inserted into the main circuit board.

The connecting part has a hook shape, so that the connecting part is elastically deformed when the connecting part passes through and is connected to the circuit board.

Further, portions of the connecting part which pass through the circuit board and are inserted into the main circuit board have different sizes.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a schematic exploded perspective view illustrating a rotatable inputting apparatus according to the preferred embodiment of the present invention;

FIG. 2 is a sectional view illustrating the rotatable inputting apparatus of FIG. 1;

FIG. 3 is an enlarged perspective view illustrating part of the rotatable inputting apparatus of FIG. 1; and

FIG. 4 is an enlarged perspective view illustrating the back of part of the rotatable inputting apparatus of FIG. 3.

### DESCRIPTION OF THE PREFERRED EMBODIMENTS

Hereinafter, a rotatable inputting apparatus according to the preferred embodiment of the present invention will be described in detail with reference to the accompanying drawings.

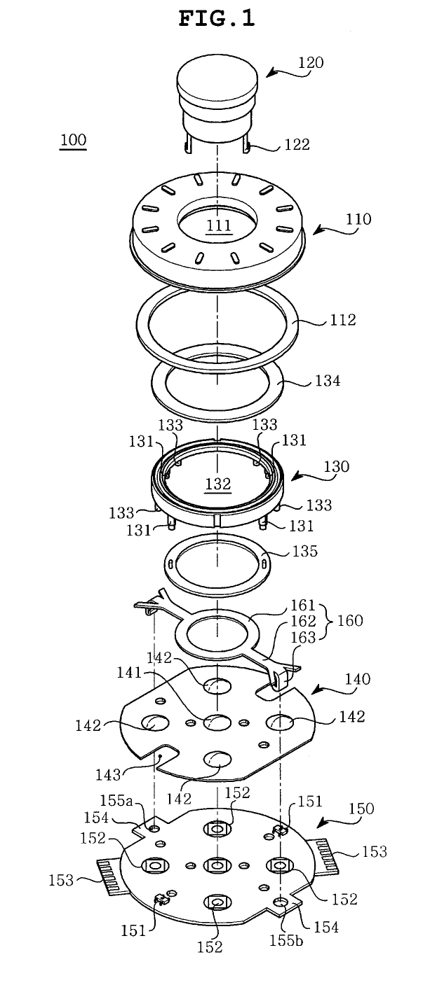

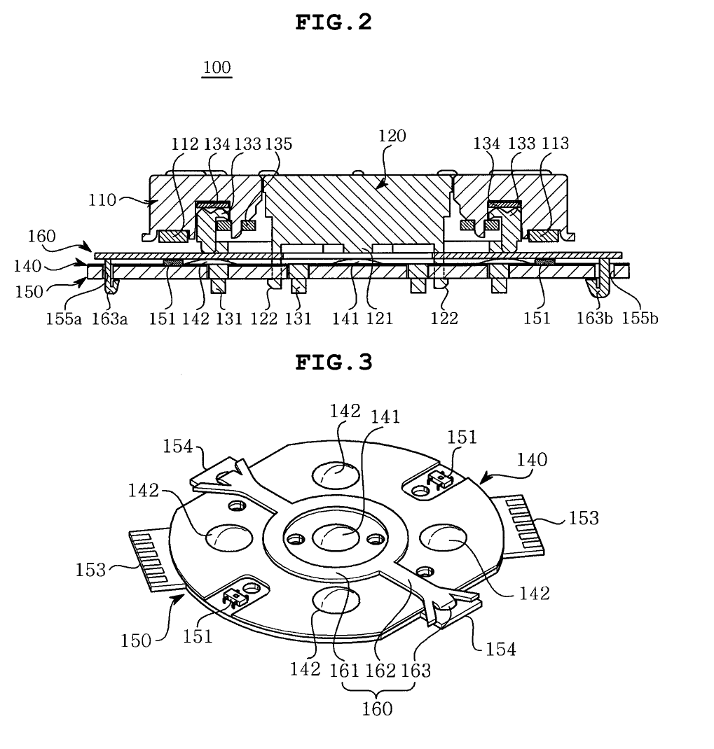

As shown in FIGS. 1 and 2, a rotatable inputting apparatus 100 according to the embodiment of the present invention includes a wheel 110, a center key 120, a support holder 130, a dome seat 140, a circuit board 150 and a connecting guide 160.

The wheel 110 is manipulated directly by a user to be rotated in a forward or backward direction. A center hole 111 is bored through the central portion of the wheel 110, and a multi-pole ring magnet 112 is provided along the edge of the bottom of the wheel 110. The wheel 110 is rotatably supported by the support holder 130.

As shown in FIG. 2, the wheel 110 is manufactured to have the shape of a disc having a predetermined thickness. An annular groove 113 is formed at a position adjacent to the lower edge of the wheel 110 in such a way as to be stepped, so that the ring magnet 112 is attached to the annular groove 113. Here, the ring magnet 112 adheres to the groove 113 using an adhesive or the like, so that the ring magnet 112 is rotated along with the wheel 110.

When the wheel 110 constructed as described above is manipulated by a user, the wheel 110 is rotated along with the ring magnet 112. The rotating angle, rotating direction, and rotating speed of the rotating wheel 110 are detected by magnetic devices 151 of the circuit board 150.

The center key 120 is a member having the shape of a cylinder which is closed at a top and bottom thereof. A center pin 121 protrudes from the center of the bottom of the center key 120 and functions to push a dome button 141 which is provided on the center of the domes seat 140. When the center key 120 is pushed by a user, the center pin 121 pushes the central dome button 141 which is provided on the center of the dome seat 140.

Such a center key 120 is provided with guide pins 122 which are inserted into guide holes formed in the dome seat 140 and the circuit board 150 such that the center key 120 is movable in a vertical direction in the wheel 110 but is not rotatable.

The support holder 130 is provided on the lower portion of the wheel 110 to rotatably support the wheel 110. Four coupling protrusions 131 are provided on the bottom of the support holder 130 at regular intervals and are coupled to the dome seat 140 and the circuit board 150. A hole 132 is formed in the central portion of the support holder 130 and has a diameter which is equal to or slightly larger than the outer diameter of the center key 120 so that the center key 120 passes through the hole 132.

Further, the support holder 130 is provided with four pressure pins 133 at positions corresponding to peripheral dome buttons 142. Thereby, when one end of the wheel 110 is pushed by a user, the pressure pins 133 push one of the four peripheral buttons 142 of the dome seat 140.

Further, a Teflon washer 134 is interposed between the support holder 130 and the wheel 110 so as to reduce friction between the wheel 110 and the upper surface of the support holder 130 when the wheel 110 is rotated. The support holder 130 has a support washer 135 which is fitted into the wheel 110 so as to prevent the wheel 110 from being removed from the support holder 130.

The dome seat 140 has the central dome button 141 which is provided on the central portion to correspond to the center key 120, and the four peripheral dome buttons 142 which are provided around the central dome button 141. The four peripheral dome buttons 142 are arranged to be pressed by the four pressure pins 133 which are provided on the support holder 130.

Here, when the central dome button 141 and the four peripheral dome buttons 142 are pressed by the center key 120 and the pressure pins 133 of the support holder 130, the central dome button 141 and the peripheral dome buttons 142 are elastically deformed. The deformation of the central and peripheral dome buttons 141 and 142 is deformed by circuits 152 formed on the circuit board 150, so that a signal is generated. Using the signal, the function of a terminal or remote control is performed.

Further, the dome seat 140 is cut at portions corresponding to the magnetic devices 151 to form cut parts 143, in such a way that the magnetic devices 151 provided on the circuit board 150 face the ring magnet 112.

The circuit board 150 is placed on the lower surface of the dome seat 140 to support the dome seat 140. The magnetic devices 151 which detect the magnetic variation of the ring magnet 112 and the circuits 152 which detect the deformation of the central and peripheral dome buttons 141 and 142 and generate a signal are provided on the upper surface of the dome seat 140. Further, the circuit board 150 is provided with terminal parts 153 which transmit the signal from the magnetic devices 151 and the central and peripheral dome buttons 141 and 142 to a main circuit board of the terminal or remote control.

Further, connecting pieces 154 protrude integrally from both sides of the circuit board 150 so that the connecting guide 160 is connected to the circuit board 150. First and second connecting holes 155a and 155b having different diameters are formed in the connecting pieces 154 for the connection with the connecting guide 160.

The connecting guide 160 serves to connect the circuit board 150 to which the dome seat 140 is attached to the main circuit board of the remote control or terminal. The connecting guide 160 includes a ring part 161 which surrounds the central dome button 141, extension parts 162 which extend from opposite ends of the ring part 161, and connecting parts 162 which extend vertically from ends of the corresponding extension parts 162 to pass through the circuit board 150.

Preferably, the ring part 161 and the extension parts 162 of the connecting guide 160 are thin so as not to interfere with the pushing operation of the center key 120 and the pressure pins 133.

The connecting parts 163 are inserted, respectively, into the first and second connecting holes 155a and 155b which are formed in the connecting pieces 154 of the circuit board 150. As shown in FIG. 2, one end of each connecting part 163 is bent inwards to have a hook-shaped section. Thereby, when the connecting parts 163 are inserted into the first and second connecting holes 155a and 155b, the connecting parts 163 are elastically deformed at ends thereof to be secured to the first and second connecting holes 155a and 155b.

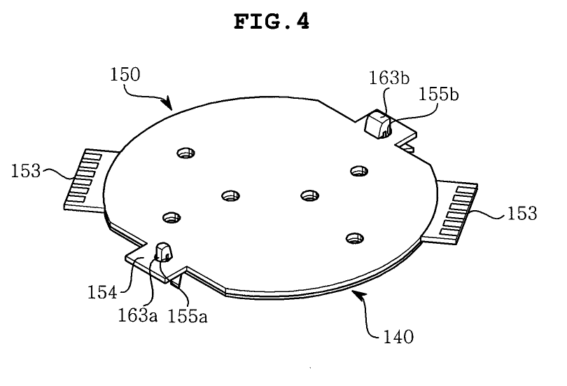

Preferably, as shown in FIGS. 3 and 4, the portions of the connecting parts 163 which protrude to the lower surface of the circuit board 150 have different sizes. Thereby, when the rotatable inputting apparatus 100 is mounted to the main board of the terminal or remote control after the wheel 110, the center key 120, and other parts of the rotatable inputting apparatus 100 are assembled with each other, a worker may instinctively know the mounting direction of the rotatable inputting apparatus 100 based on the size of each connecting part 163.

In detail, fastening holes having different sizes are formed in the main circuit board of the remote control or the like, and the portions of the connecting parts 163 which protrude to the lower surface of the circuit board 150 are inserted into the corresponding fastening holes, thus allowing a worker to more easily control the mounting direction of the rotatable inputting apparatus 100.

The rotatable inputting apparatus 100 constructed as described above is assembled as follows.

First, as shown in FIGS. 3 and 4, after the dome seat 140 is attached to the circuit board 150, the connecting parts 163 of the connecting guide 160 are inserted into the first and second connecting holes 155a and 155b so that the connecting guide 160 presses the upper surface of the dome seat 140.

Subsequently, as shown in FIG. 1, the support holder 130, the center key 120 and the wheel 110 are sequentially mounted on the dome seat 140, so that the assembly of the rotatable inputting apparatus 100 is completed.

Next, although not shown in the drawings, the connecting parts 163 which protrude to the lower surface of the circuit board 150 of the rotatable inputting apparatus 100 are inserted into the main circuit board of the remote control or terminal. Here, since the connecting parts 163 have different sizes, the reference position of the rotatable inputting apparatus 100 can be precisely seen by a worker's eyes, and the assembly of the rotatable inputting apparatus 100 can be easily performed.

According to the present invention, connecting parts of a connecting guide mounted on a circuit board of a rotatable inputting apparatus pass through the circuit board to be inserted into a main circuit board of an objective product, thus allowing the rotatable inputting apparatus to be easily assembled with the main circuit board of the objective product without using screws, thus simplifying the assembly process.

Further, the connecting parts of the connecting guide have different sizes, thus allowing a worker to instinctively know the reference position of the rotatable inputting apparatus, therefore considerably reducing the assembly period.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A rotatable inputting apparatus mounted to a product having a main circuit board, comprising:
a wheel having in a central portion thereof a center hole, rotated by a rotating manipulating force, and having a ring magnet;
a support holder for rotatably supporting the wheel, and having on an edge thereof at least one pressure pin;
a center key passing through the center hole of the wheel, and moving in a vertical direction;
a dome seat including a central dome button which generates a signal by pushing force of the center key and the pressure pin, and one or more peripheral dome buttons provided around the central dome button at regular intervals;
a circuit board including a circuit for transmitting a signal from the central and peripheral dome buttons, and a magnetic device for detecting a rotation of the ring magnet of the wheel, the dome seat being attached to an upper surface of the circuit board; and
a connecting guide coming in close contact with the upper surface of the circuit board such that at least portion of the connecting guide is exposed to a lower surface of the circuit board, the exposed portion being inserted into the main circuit board to connect the circuit board to the main circuit board.

2. The rotatable inputting apparatus as set forth in claim 1, wherein the circuit board comprises on an outer circumference thereof two connecting pieces in which first and second through holes are formed, respectively, portion of the connecting guide being connected to the first and second through holes.

3. The rotatable inputting apparatus as set forth in claim 2, wherein the first and second through holes have different diameters.

4. The rotatable inputting apparatus as set forth in claim 1, wherein the connecting guide comprises:
a ring part coming into close contact with the dome seat in such a way as to surround the central dome button;
an extension part extending from each of opposite ends of the ring part and coming into close contact with the dome seat; and
a connecting part extending vertically from an end of the extension part to pass through the circuit board and thereby be inserted into the main circuit board.

5. The rotatable inputting apparatus as set forth in claim 4, wherein the connecting part has a hook shape, so that the connecting part is elastically deformed when the connecting part passes through and is connected to the circuit board.

6. The rotatable inputting apparatus as set forth in claim 4, wherein portions of the connecting part which pass through the circuit board and are inserted into the main circuit board have different sizes.
